(19) United States
(12) Patent Application Publication
(10) Pub. No.: US 2025/0182461 A1
(43) Pub. Date: Jun. 5, 2025

(54) STYLIZED TRAINING DATA SYNTHESIS FOR TRAINING A MACHINE-LEARNING MODEL

(71) Applicant: Adobe Inc., San Jose, CA (US)

(72) Inventors: John Philip Collomosse, Surrey (GB); Dan Sebastian Ruta, Surrey (GB)

(73) Assignee: Adobe Inc., San Jose, CA (US)

(21) Appl. No.: 18/527,908

(22) Filed: Dec. 4, 2023

(51) Int. Cl. G06V 10/82; G06V 10/771

(52) U.S. Cl. CPC G06V 10/82; G06V 10/771

(57) ABSTRACT

Stylized training data synthesis techniques are described for training a machine-learning model. In one or more examples, a style training system selects a style example exhibiting a style that is to be subject of training a machine-learning model. The style training system also selects a collection of subject matter examples having different instances of subject matter. The style training system then synthesizes stylized training data based on the style example and subject matter examples, e.g., using a neural transfer technique. The stylized training data is then usable to train a machine-learning model to learn a representation of style that has limited influence by the subject matter being expressed by the digital content.

### BACKGROUND

Style, as used in reference to digital content, refers to distinct aesthetic elements and principles that characterize the digital content. In an example in which the digital content is configured as a digital image, for instance, visual style may be characterized by color palettes and schemes, shapes and lines, textures, lighting, patterns, perspective, contrast, saturation, and so forth. Other examples include use of language in a digital book, use of tones in digital audio, and so on. Thus, style is used to define “how” the digital content is expressed (e.g., by an artist) as opposed to “what” is included within the digital content.

Style, therefore, introduces a multitude of technical challenges in functionality implemented by computing devices in order to address the nuances of style, e.g., as part of a search. These technical challenges in conventional examples result in inaccuracies, inefficient use of computational resources and power consumption, and reduced user efficiency and increased user frustration.

### SUMMARY

Stylized training data synthesis techniques are described for training a machine-learning model. In one or more examples, a style training system selects a style example exhibiting a style that is to be subject of training a machine-learning model. The style training system also selects a collection of subject matter examples having different instances of subject matter. The style training system then synthesizes stylized training data based on the style example and subject matter examples, e.g., using a neural transfer technique. The stylized training data is usable to train a machine-learning model to learn a representation of style that has limited influence by the subject matter being expressed by the digital content.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ stylized training data synthesis techniques for training a machine-learning model as described herein.

FIG. 2 depicts a system in an example implementation showing operation of a style training system of FIG. 1 in greater detail as synthesizing stylized training data.

FIG. 3 depicts an example implementation showing operation of the style transfer system of FIG. 2 in greater detail as implementing neural style transfer.

FIG. 4 depicts an example implementation showing operation of the style training system of FIG. 3 in greater detail as implementing neural style transfer.

FIG. 5 depicts an example implementation showing implementation of contrastive losses for a stylized and ground truth.

FIG. 6 is a flow diagram depicting an algorithm as a step-by-step procedure in an example implementation of operations performable for accomplishing a result of stylized training data synthesis techniques for training and using a machine-learning model.

FIG. 7 illustrates an example system including various components of an example device that can be implemented as any type of computing device as described and/or utilize with reference to the previous figures to implement embodiments of the techniques described herein.

### DETAILED DESCRIPTION

### Overview

Style refers to distinct aesthetic elements and principles that are usable to characterize digital content. Style therefore describes “how” the digital content is expressed, which differs from “what” is exhibited in the digital content, i.e., a subject matter of the digital content. Artists that create digital images, for instance, often employ a particular style that is readily identifiable as being associated with that artist through use of color palettes and schemes, shapes and lines, textures, lighting, patterns, perspective, contrast, saturation, and so forth.

Style, therefore, introduces a multitude of technical challenges in functionality implemented by computing devices to address the nuances of style, e.g., as part of a search. Conventional techniques used to search for a particular style, for instance, are typically confronted with examples of digital images that also include similar subject matter. For example, artists in real world scenarios often create digital images in a particular style having similar subject matter, e.g., haystacks, ballerinas, and so forth.

Consequently, conventional techniques used to locate the particular style suffer inaccuracies due to similarity of subject matter used as a basis to make that determination, e.g., to train a machine-learning model. In other words, conventional techniques in real world scenarios have limited accuracy in identifying a style that does not also include similar subject matter. These technical challenges in conventional examples result in inaccuracies, inefficient use of computational resources and power consumption, and reduced user efficiency and increased user frustration.

Accordingly, to address these and other technical challenges stylized training data synthesis techniques are described for training a machine-learning model. These techniques synthesize training data that disentangles style from subject matter of the digital content. In this way, a machine-learning model is trainable to learn a representation of style that has limited influence by the subject matter being expressed by the digital content.

In one or more examples, a style training system obtains access to a digital content corpus of digital content, e.g., digital images, digital documents, digital audio, digital video, and so forth. The style training system selects a style example exhibiting a style that is to be subject of training a machine-learning model. The style training system also selects a collection of subject matter examples having different instances of subject matter, e.g., different objects in a digital image, different topics in a document, and so forth.

The style training system then synthesizes stylized training data based on the style example and subject matter examples. To do so, the styles transfer system employs a machine-learning model (e.g., a neural style transfer model) that is configured to transfer the style as expressed by the style example to the subject matter examples. In a digital image example, a style example of a watercolor is transferred to subject matter examples depicting different objects, e.g., a car, tree, dog, or other semantic content. Accordingly, the stylized training data includes a collection of digital images of the car, tree, dog, and so on having the watercolor style. This operation is performed for a variety of styles.

The stylized training data is then used to train a style machine-learning model, e.g., using a contrastive loss. The style training system, for instance, selects a positive example from the stylized training data having the watercolor style and a subject matter of a car. The style training system also selects a negative example that exhibits a different style (e.g., a woodblock print), but may have the same subject matter. In this way, the style machine-learning model is trained to learn the style that is disentangled from the subject matter included in the digital content. The style machine-learning model, once trained, is usable to support a variety of functionality, an example of which includes a search of digital content as part of a digital service, clustering techniques, tagging techniques, and so forth. Further discussion of these and other examples is included in the following sections and shown in corresponding figures.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Stylized Training Data Environment

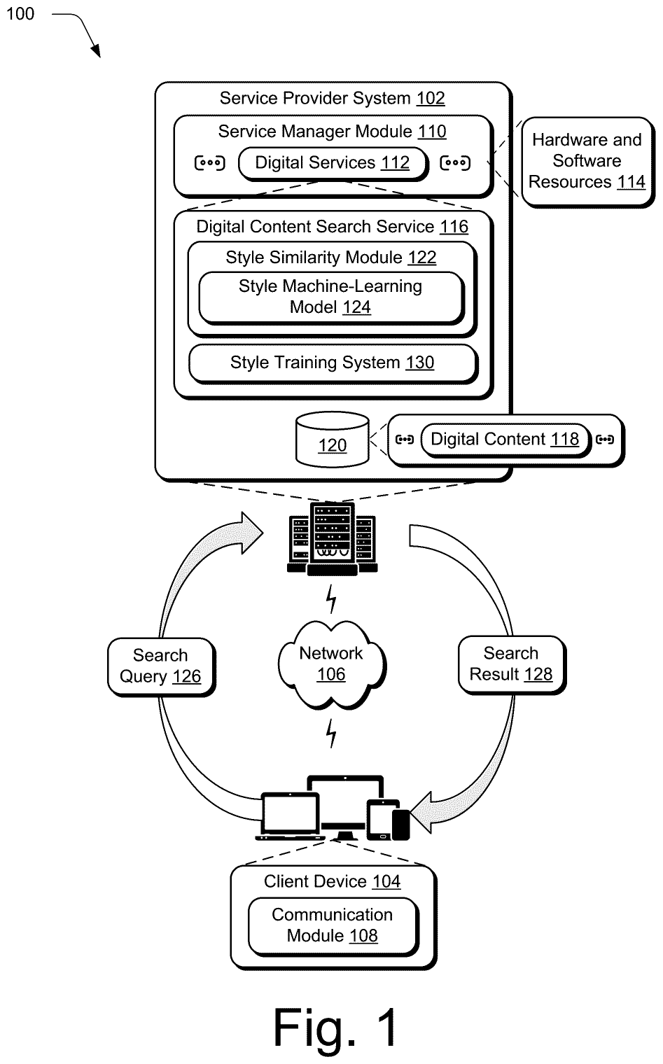

FIG. 1 is an illustration of a digital medium environment 100 in an example implementation that is operable to employ stylized training data synthesis techniques for training a machine-learning model as described herein. The illustrated environment 100 includes a service provider system 102 and a client device 104 that are communicatively coupled, one to another, via a network 106. Computing devices that implement the service provider system 102 and the client device 104 are configurable in a variety of ways.

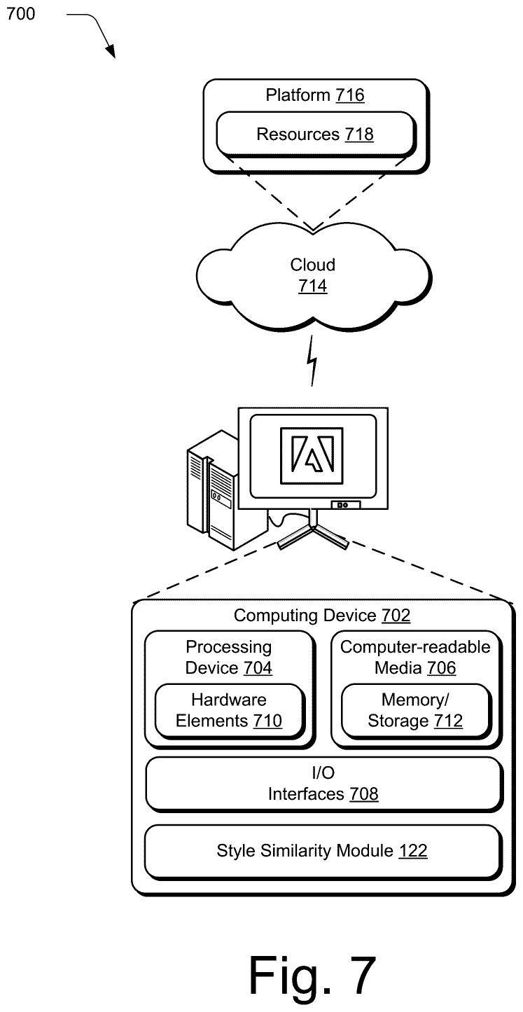

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is described in some examples, a computing device is also representative of a plurality of different devices, such as multiple servers utilized by a business to perform operations “over the cloud” as described in FIG. 7.

The client device 104 includes a communication module 108 that is representative of functionality to communicate via the network 106 with a service manager module 110 of the service provider system 102. The service manager module 110 is configured to implement digital services 112 using hardware and software resources 114, e.g., a processing device and a computer-readable storage medium. Digital services 112 are usable to expose a variety of functionality to the client device 104, an example of which is illustrated as a digital content search service 116. The digital content search service 116 is configured to perform a search of digital content 118, illustrated as stored in a storage device 120. Digital content 118 is configurable in a variety of ways, examples of which include digital images, digital documents, digital audio, digital video, and so forth.

In order to support a search of the digital content 118 based on style (e.g., for clustering, responsive to a search query, and so on), the digital content search service 116 employs a style similarity module 122. The style similarity module 122 utilizes a style machine-learning model 124 as a basis to perform a search of the digital content 118 for a particular style. The style machine-learning model 124, for instance, is configured to extract a set of features and create a hierarchy of the features as a feature representation. Therefore, upon receipt of a search query 126 the style machine-learning model 124 utilizes the features to determine similarity of the digital content 118 to the search query 126 and generate a search result 128 having representations of items of digital content 118 based on the search.

As previously described, however, digital content search involving style is confronted with numerous technical challenges. For example, artists in real world scenarios often create digital images in a particular style having similar subject matter. Consequently, conventional techniques used to locate the particular style suffer inaccuracies due to similarity of subject matter used as a basis to make that determination. These technical challenges in conventional examples result in inaccuracies, inefficient use of computational resources and power consumption, and reduced user efficiency due to these inaccuracies and increased user frustration.

Accordingly, a style training system 130 is employed by the digital content search service 116. The style training system 130 is configured to train the style machine-learning model 124 to overcome these technical challenges by separating identification of style from identification of subject matter exhibited by the digital content 118. In this way, the style machine-learning model 124 improves computational functional and operation of functionality that is dependent on the style machine-learning model 124, e.g., a digital content search service 116. Further discussion of these and other examples is included in the following section and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Stylized Training Data Synthesis Techniques

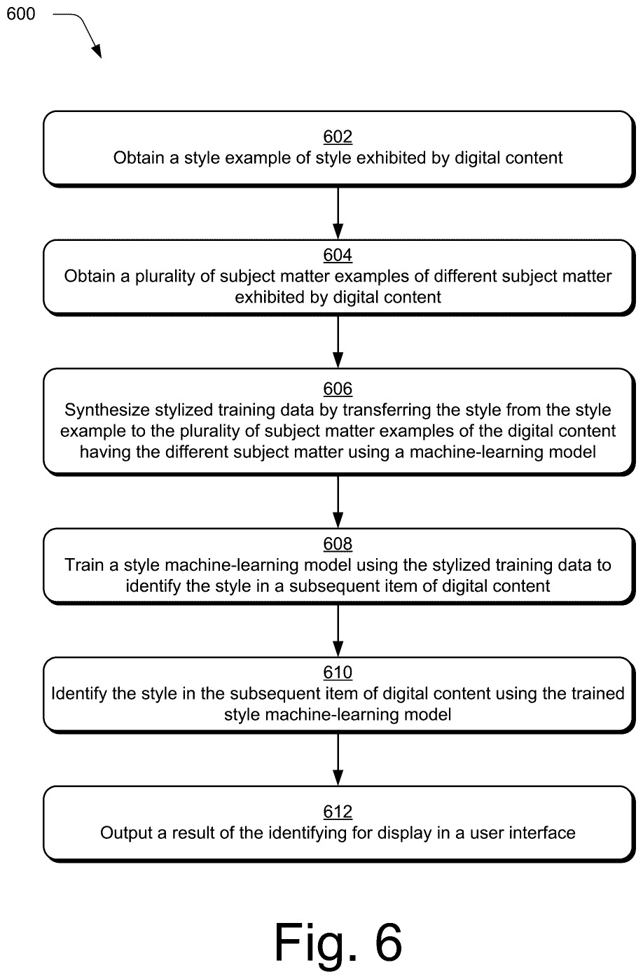

The following discussion describes stylized training data synthesis techniques for training a machine-learning model that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform algorithm. In portions of the following discussion, reference will be made in parallel to FIG. 6, which is a flow diagram depicting an algorithm 600 as a step-by-step procedure in an example implementation of operations performable for accomplishing a result of stylized training data synthesis techniques for training and using a machine-learning model.

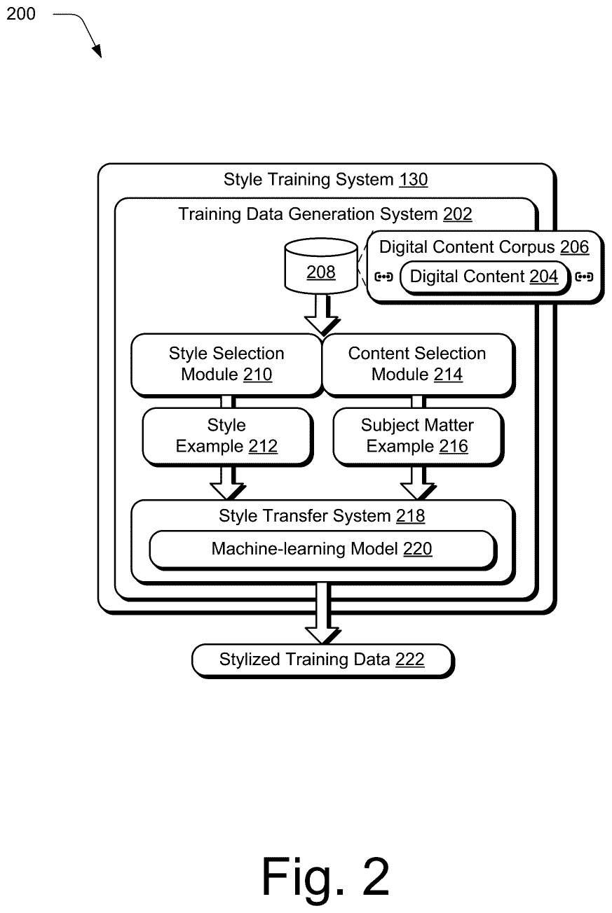

FIG. 2 depicts a system 200 in an example implementation showing operation of the style training system 130 of FIG. 1 in greater detail as synthesizing stylized training data. The style training system 130 includes a training data generation system 202 that is representative of functionality to generate training data that is usable to train the style machine-learning model 124. To do so, the training data generation system 202 starts with digital content 204 from a digital content corpus 206 maintained in a storage device 208. The digital content corpus 206, for instance, is configurable to represent a plurality of digital content sources, which may be maintained locally by the service provider system 102, remotely accessible via the network 106, and so forth.

A style selection module 210 is then leveraged to obtain a style example 212 of a style exhibited by digital content (block 602). The style selection module 210, for instance, outputs a user interface via which an item of digital content is selected that exhibits a desired style that is to be used as a basis for training. In this example, a style example 212 is obtained for a plurality of different styles. Styles may range from visual (e.g., as expressed in a digital image), audio phrasing (e.g., melodic themes as expressed in digital audio), a literary style (e.g., as expressed in a digital document), cinematic (e.g., as expressed in a digital video), and other semantic concept. Therefore, although the following example involves a digital image and a visual style, styles may variety over a wide range of digital content types.

A content selection module 214 is also employed by the training data generation system 202 to obtain subject matter examples 216 of different subject matter exhibited by digital content (block 604). The subject matter examples 216 define different types of subject matter that are expressible by corresponding types of digital content, e.g., objects depicted in a digital image, a topic of a digital document, and so forth.

The style example 212 and the subject matter examples 216 are then received as inputs by a style transfer system 218. The style transfer system 218 is configured to employ a machine-learning model 220 to synthesize stylized training data 222. The machine-learning model 220 does so by transferring the style from the style example 212 to the subject matter examples 216 of the digital content 204 having the different subject matter (block 606).

The machine-learning model 220, for instance, is configurable to implement neural style transfer (NST) having an encoder/decoder architecture that employs machine learning to blend a style of an item of digital content (e.g., a digital image of the style example 212) with subject matter of another digital image, e.g., the subject matter examples 216. To do so, the machine-learning model 220 employs feature extraction, e.g., using convolutional neural networks. Loss functions are employed that measure a content loss to control generation of the subject matter in the stylized training data 222 and a style loss to control inclusion of style in the stylized training data 222 from the style example 212. These operations are performable as part of an iterative process using gradient descent optimization techniques (e.g., based on a stopping criterion) to arrive at a synthesized item of digital content as an example of the stylized training data 222.

The machine-learning model 220, through use of neural style transfer, is thus able to synthesize stylistic variants of semantic content for self-supervised training. Use of neural style transfer to induce style in the stylized training data 222 addresses a long tail distribution typically found in conventional large stylistic datasets. Long tail distributions, for instance, are observable in scenarios in which where certain styles (e.g., illustration) are common, and certain other styles (e.g., fine art) have increased rarity. This imbalance leads to reduced embedding performance on rarer styles. Additionally, by explicitly applying a variety of stylizations to a given piece of semantic content, disentanglement in the stylized training data 222 is ensured, which leads to improved disentanglement of the learned representation.

Style is an ever evolving and complex concept. Therefore, capture of this subject information related to style using a machine-learning model involves numerous technical challenges. In a comparative setting, similarities and differences between two stylistically similar images are usable to obtains a hint about common properties. A technical challenge with automated approaches and human judgment, however, involves separating and disentangling style from the subject matter as previously described. This challenge is especially an issue in the comparative case, where two stylistically similar images often represent the same subject matter.

Identification of style provides underlying support for a variety of functionalities. A search of digital content, for instance, may be style based as shown in the example of FIG. 1. Other functionalities include clustering digital content for analysis or display based on style, style conditioned image generation, stylization using a style embedding for fine-grained control, and so forth. Accordingly, disentanglement in embeddings as part of machine learning is relied upon in a variety of multimodal applications, where a clean disentangled signal of the given modality is used as a basis for alignment with other modalities. Thus, improvements to the disentanglement of embeddings for a modality such as style supports functionality to cleanly expose desired style features without semantic information.

In the techniques described herein, digital content synthesis is leveraged to learn disentangled representations of style without being affected by semantic data biases found typically in human-generated examples, e.g., which typically have similar subject matter. As a result, the stylized training data 222 supports training of a machine-learning model that has a high variance in the semantic content depicted but has a consistent style. The training data generation system 202 is thus usable to synthesize the stylized training data 222 where the style is consistent, but where the subject matter varies depending on a source of the subject matter examples 216.

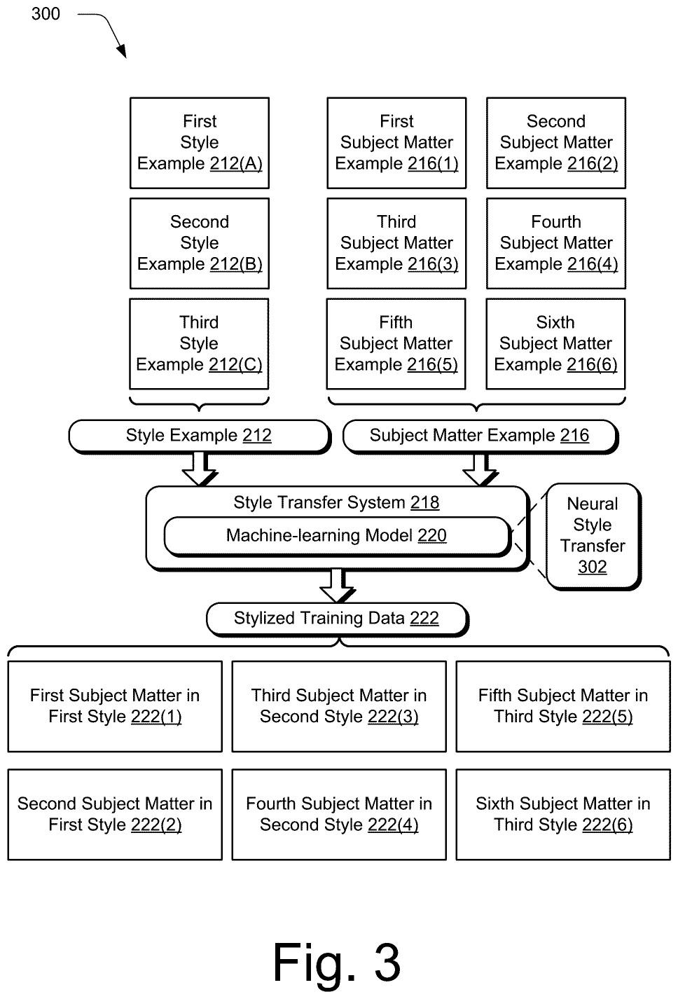

FIG. 3 depicts an example implementation 300 showing operation of the style transfer system 218 of FIG. 2 in greater detail as implementing neural style transfer 302. The machine-learning model 220 of the style transfer system 218, for instance, receives style examples 212 including a first style example 212(A), a second style example 212(B), and a third style example 212(C). Likewise, the style transfer system 218 also receives a plurality of subject matter examples 216, illustrated examples of which include a first subject matter example 216(1), a second subject matter example 216(2), a third subject matter example 216(3), a fourth subject matter example 216(4), a fifth subject matter example 216(5), and a sixth subject matter example 216(6).

The machine-learning model 220 is then employed by the style transfer system 218 to generate the stylized training data 222. Examples of instances of the stylized training data 222 include the first subject matter in the first style 222(1), the second subject matter in the first style 222(2), the third subject matter in the second style 222(3), the fourth subject matter in the second style 222(4), the fifth subject matter in the third style 222(5), and the sixth subject matter in the third style 222(6). Thus, each style example 212 is used along with at least two subject matter examples 216 to generate a pair of stylized training data 222 such that the content has the same style but arbitrary semantic content. The stylized training data 222 is then used to train the style machine-learning model 124, an example of which is described in the following discussion and shown in a corresponding figure.

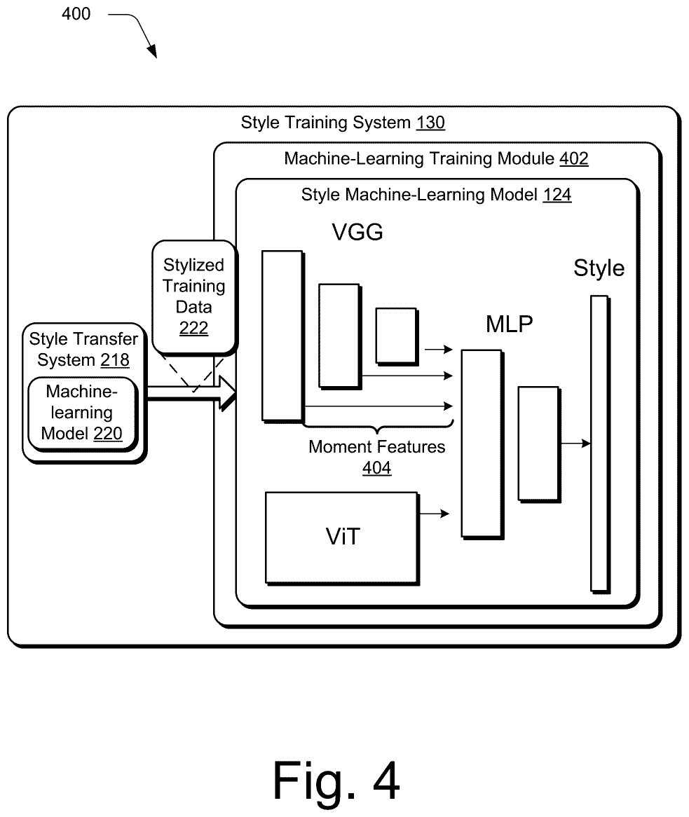

FIG. 4 depicts an example implementation 400 showing operation of the style training system 130 in greater detail as implementing neural style transfer 302. The style training system 130 is illustrated as including a machine-learning training module 402 that is representative of functionality to control training of the style machine-learning model 124 based on the stylized training data 222. The style machine-learning model 124, once trained, is configured to identify the style in a subsequent item of digital content (block 608), e.g., as part of a search, clustering technique, and so forth.

In an implementation, dynamic fast, feed-forward NST techniques are utilized by the style transfer system 218 to generate the stylized training data 222 in real time to train the style machine-learning model 124. As a result, the style training system 130 to maximize a number of styles that may be used for training without the impractical storage space involved in precomputing the stylized training data 222.

A style learning signal is induced through contrastive losses computed amongst the items of digital content synthesized by the style transfer system 218 and a style example 212 as a reference. In an implementation, approximately half of the style examples 212 are sampled in a batch to synthesize two items of stylized training data 222 with the same style in each batch, for each style. For the stylized training data 222, items having a same style are utilized as positive training data and the remaining items of stylized training data 222 in the batch (e.g., having different styles) are used as negative training data. This encourages the embedding of the style machine-learning model 124 to represent the style information shared in the stylized pairs, regardless of the subject matter included, which is random. Contrastive losses are used to drive the learning signal using this self-supervised approach.

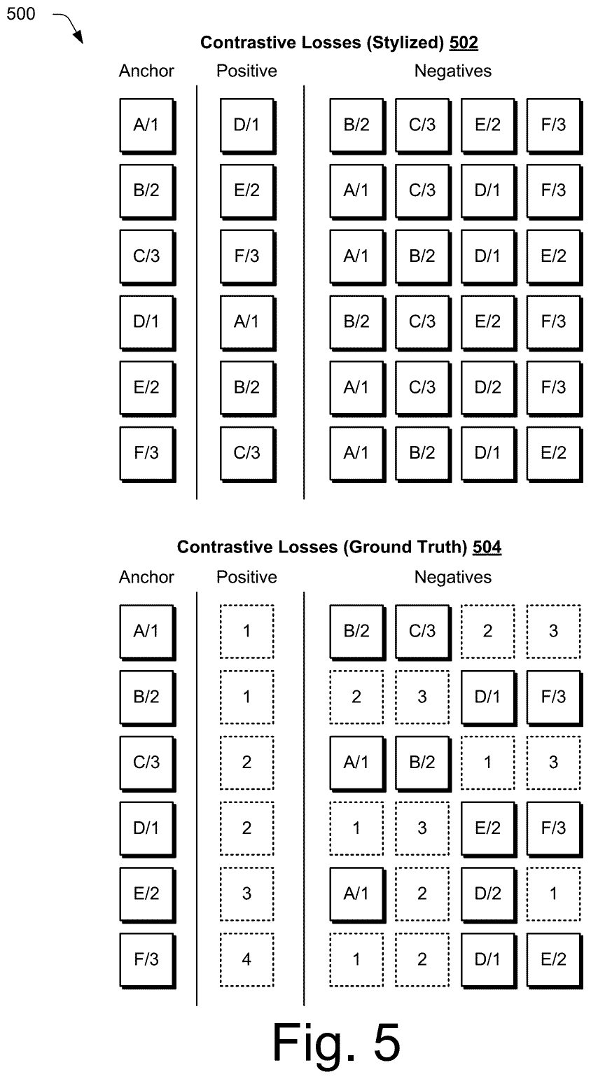

FIG. 5 depicts an example implementation 500 showing implementation of contrastive losses for a stylized 502 and ground truth 504. In this example, a naming convention is utilized to indicate style from FIG. 3 by letter (e.g., “A,” “B,” “C”) and indicate respective subject matter by number. Therefore, a synthesized item of digital content of “A/1” corresponds to the first subject matter in the first style 222(1).

A set of contrastive losses are computed for each synthesized item of digital content in the batch. The positive sample is the other sample in the batch where the same original style example is used as a style reference during stylization. As half the number of style examples are selected per batch, there are two items of stylized training data 222 with the same style. The negative samples in the contrastive losses are thus the remaining images in the batch, which are stylized with other randomly sampled items of stylized training data 222 in the batch. Additional sets of contrastive losses compare the stylized training data 222 embeddings to the embeddings of the subject matter examples 216. Dashed squares represent ground truth embeddings.

Returning again to FIG. 4, given the stylized training data 222, moment features 404 are computed by a visual geometry group (illustrated as “VGG”) network in the illustrated example to train a multilayer perceptron (illustrated as “MLP”). Standard statistics used are mean and variance. The moment features 404, for instance, represent the first and second moments in an implementation, although use of higher order moments are also contemplated. The first four moments, for instance, are utilized in an implementation thereby further extracting skewness and kurtosis from feature statistics in the VGG branch. The skewness formula is shown in Equation 2 below, calculated via the “z” scores from Equation 1, and kurtosis is shown in Equation 3, where a positive value indicates a leptokurtic data distribution, and a negative value indicates a platykurtic distribution, i.e., measures tails of the data distribution.

$${z}_{scores} = \frac{X - μ}{σ} \qquad ( 1 )$$

$${m}_{3} = \frac{\sum {z}_{scores}^{3}}{n} \qquad ( 2 )$$

$${m}_{4} = \frac{\sum {z}_{scores}^{4}}{n} - 3 \qquad ( 3 )$$

Highly expressive features are also extracted using a vision transformer (illustrated as “ViT” in FIG. 4) model to capture localized features in stylized training data 222 formed using a digital image. These embeddings are concatenated and project them into a 1024 dimension style vector depicted as “Style” as shown in FIG. 4.

The loss objective employed by the machine-learning training module 402 is a standard contrastive loss, shown in Equation 6 below, where “A” represents the machine-learning model 220, “xₛ” and “x_{c}” represent style and subject matter (e.g., the style example 212 and the subject matter examples 216), respectively, and NST represents a randomly sampled NST technique from the techniques used to stylize xₛ” and “x_{c}” into “SS.”

$${𝒮}_{sc} = NST ( {x}_{s} , {x}_{c} ) \qquad ( 4 )$$

$$pos = {𝒜 ( {𝒮}_{sc} )}_{a}^{T} {𝒜 ( {𝒮}_{sc} )}_{p} / τ \qquad ( 5 )$$

$$ℒ := - log ( \frac{exp ( pos )}{exp ( pos ) + \sum exp ( {𝒜 ( {𝒮}_{sc} )}_{a}^{T} {𝒜 ( {𝒮}_{sc} )}_{n} / τ )} ) \qquad ( 6 )$$

Due to the cross-NST approach in the style representation learning signal from the style transfer system 218, in an implementation two million images in each of the content and style splits of a digital content corpus 206 lead to a synthetic dataset of effectively four trillion images. This creates a practically limitless combination of style and subject matter during training. Once trained, the style machine-learning model 124 is configured to identify the style in the subsequent item of digital content (block 610), a result of which is output for display in a user interface (block 612).

As a result, the style similarity module 122, style training system 130, and style machine-learning model 124 are usable to support a variety of advantages and overcome conventional technical challenges. The style machine-learning model 124, for instance, is usable as part of a digital content search service 116 to find and describe digital content based on fine-grained differences in artistic style. This functionality supports search and digital content recommendations. These techniques support search over diverse collections of digital content having considerable style diversity, and the aesthetics of the digital content hold significant weight in determining the relevance of the digital content. When combined with a language model (e.g., using generative artificial intelligence) the advantage of a fine-grained style embedding supports an ability to discriminate between similar styles and also generate free-form text tags (keywords) with further applications to style captions, description and as a basis for text based search. The training approach implemented by the machine-learning training module 402 is self-supervised and does not involve explicit labelling of digital content to specific styles in order to train the model. Rather, individual styles are selected from exemplar samples in the data and applied to other samples in the dataset without assigning a name or ontology to the styles present. This enables scaling over training data volumes and leads to greater style diversity as additional data may be leveraged from a variety of platforms where explicit style labels are not present or difficult to define.

### Example System and Device

FIG. 7 illustrates an example system generally at 700 that includes an example computing device 702 that is representative of one or more computing systems and/or devices that implement the various techniques described herein. This is illustrated through inclusion of the style similarity module 122 of FIG. 1. The computing device 702 is configurable, for example, as a server of a service provider, a device associated with a client (e.g., a client device), an on-chip system, and/or any other suitable computing device or computing system.

The example computing device 702 as illustrated includes a processing device 704, one or more computer-readable media 706, and one or more I/O interface 708 that are communicatively coupled, one to another. Although not shown, the computing device 702 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 704 is representative of functionality to perform one or more operations using hardware. Accordingly, the processing device 704 is illustrated as including hardware element 710 that is configurable as processors, functional blocks, and so forth. This includes implementation in hardware as an application specific integrated circuit or other logic device formed using one or more semiconductors. The hardware elements 710 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 706 is illustrated as including memory/storage 712 that stores instructions that are executable to cause the processing device 704 to perform operations. The memory/storage 712 represents memory/storage capacity associated with one or more computer-readable media. The memory/storage 712 includes volatile media (such as random access memory (RAM)) and/or nonvolatile media (such as read only memory (ROM), Flash memory, optical disks, magnetic disks, and so forth). The memory/storage 712 includes fixed media (e.g., RAM, ROM, a fixed hard drive, and so on) as well as removable media (e.g., Flash memory, a removable hard drive, an optical disc, and so forth). The computer-readable media 706 is configurable in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 702. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 702, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 710. The computing device 702 is configured to implement particular instructions and/or functions corresponding to the software and/or hardware modules. Accordingly, implementation of a module that is executable by the computing device 702 as software is achieved at least partially in hardware, e.g., through use of computer-readable storage media and/or hardware elements 710 of the processing device 704. The instructions and/or functions are executable/operable by one or more articles of manufacture (for example, one or more computing devices 702 and/or processing devices 704) to implement techniques, modules, and examples described herein.

The techniques described herein are supported by various configurations of the computing device 702 and are not limited to the specific examples of the techniques described herein. This functionality is also implementable all or in part through use of a distributed system, such as over a “cloud” 714 via a platform 716 as described below.

The cloud 714 includes and/or is representative of a platform 716 for resources 718. The platform 716 abstracts underlying functionality of hardware (e.g., servers) and software resources of the cloud 714. The resources 718 include applications and/or data that can be utilized while computer processing is executed on servers that are remote from the computing device 702. Resources 718 can also include services provided over the Internet and/or through a subscriber network, such as a cellular or Wi-Fi network.

The platform 716 abstracts resources and functions to connect the computing device 702 with other computing devices. The platform 716 also serves to abstract scaling of resources to provide a corresponding level of scale to encountered demand for the resources 718 that are implemented via the platform 716. Accordingly, in an interconnected device embodiment, implementation of functionality described herein is distributable throughout the system 700. For example, the functionality is implementable in part on the computing device 702 as well as via the platform 716 that abstracts the functionality of the cloud 714.

In implementations, the platform 716 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
obtaining, by a processing device, a style example of style exhibited by digital content and a plurality of subject matter examples of different subject matter exhibited by digital content;
synthesizing, by the processing device, stylized training data by transferring the style from the style example to the plurality of subject matter examples of the digital content having the different subject matter using a machine-learning model; and
training, by the processing device, a style machine-learning model using the stylized training data to identify the style in a subsequent item of digital content.

2. The method as described in claim 1, wherein the digital content is a digital image and the style is a visual style depicted by the digital image.

3. The method as described in claim 2, wherein the different subject matter corresponds to different objects that are depicted in the plurality of subject matter examples, one to another.

4. The method as described in claim 1, wherein the different subject matter corresponds, respectively, to different semantic content.

5. The method as described in claim 1, wherein the training includes use of a first said item of stylized training content having the style and exhibiting first said subject matter as positive training data and a second said item having a second said style and exhibiting the first said subject matter as negative training data.

6. The method as described in claim 1, wherein the synthesizing the stylized training data is performed using a neural style transfer machine-learning model configured using an encoder-decoder architecture.

7. The method as described in claim 1, further comprising:
identifying the style in the subsequent item of digital content using the trained style machine-learning model; and
outputting a result of the identifying for display in a user interface.

8. The method as described in claim 1, wherein the synthesizing and the training are performed in real time.

9. The method as described in claim 1, wherein the training is performed using contrastive losses to drive a learning signal.

10. The method as described in claim 1, wherein the synthesizing and the training are performed for a plurality of said styles.

11. A training data generation system comprising:
a style selection module implemented by a processing device to obtain a style example of style exhibited by digital content;
a content selection module implemented by the processing device to obtain a plurality of subject matter examples of different subject matter exhibited by digital content; and
a style transfer system implemented by the processing device to synthesize stylized training data configured to train a machine-learning model to identify the style, the stylized training content synthesized by transferring the style from the style example to the plurality of subject matter examples of the digital content having the different subject matter using a machine-learning model.

12. The training data generation system as described in claim 11, wherein the digital content is a digital image, the style is a visual style depicted by the digital image, and the different subject matter corresponds to different objects that are depicted in the plurality of subject matter examples, one to another.

13. The training data generation system as described in claim 11, wherein the stylized training data is synthesized using a neural style transfer machine-learning model configured using an encoder-decoder architecture.

14. The training data generation system as described in claim 11, wherein the style transfer system is configured to use a plurality of said styles and the machine-learning model is configured to identify the plurality of said styles based on the stylized training data.

15. The training data generation system as described in claim 11, further comprising a machine-learning training module configured to train the machine-learning model using the stylized training data to identify the style in a subsequent item of digital content.

16. One-or-more computer-readable storage media storing instructions that, responsive to execution by a processing device, causes the processing device to perform operations comprising:
receiving an item of digital content;
identifying, by a machine-learning model, a style exhibited by the item of digital content, the machine-learning model trained using synthetic training data generated by transferring the style from a style example of digital content to a plurality of subject matter examples of digital content having different subject matter, one to another; and
outputting a result of the identifying for display in a user interface.

17. The one-or-more computer-readable storage media as described in claim 16, wherein the digital content is a digital image, the style is a visual style depicted by the digital image, and the different subject matter corresponds to different objects that are depicted in the plurality of subject matter examples, one to another.

18. The one-or-more computer-readable storage media as described in claim 16, wherein the synthetic training data is synthesized using a neural style transfer machine-learning model configured using an encoder-decoder architecture.

19. The one-or-more computer-readable storage media as described in claim 16, wherein the machine-learning model is trained using a first said item of stylized training content having the style and exhibiting first said subject matter as positive training data and a second said item having a second said style and exhibiting the first said subject matter as negative training data.

20. The one-or-more computer-readable storage media as described in claim 16, wherein the identifying of the style includes identifying the style from a plurality of said styles using the machine-learning model.
